(19) United States
(12) Patent Application Publication
(10) Pub. No.: US 2014/0021328 A1
(43) Pub. Date: Jan. 23, 2014

(54) WINCH MOUNT ASSEMBLY AND METHODS OF FORMING AND INSTALLING A WINCH MOUNT ASSEMBLY

(71) Applicant: Gregory Neal HIGGS, Fort Mill, SC (US)

(72) Inventor: Gregory Neal HIGGS, Fort Mill, SC (US)

(73) Assignee: FAB FOURS INC., Lancaster, SC (US)

(21) Appl. No.: 13/551,111

(22) Filed: Jul. 17, 2012

(51) Int. Cl. B60R 11/00; B23K 31/02; B23P 11/00; F16M 13/02

(52) U.S. Cl. 248/674; 228/101; 29/428

(57) ABSTRACT

A vehicle winch mount assembly includes a main section; a driver side mount that is to be mounted to a vehicle and that is integrated with the main section; and a passenger side mount that is to be mounted to the vehicle and that is integrated with the main section. A method of forming a vehicle winch mount assembly includes integrating a driver side mount that is to be mounted to a vehicle with a main section; and integrating a passenger side mount that is to be mounted to a vehicle with the main section.

### BACKGROUND

The disclosure relates to a winch mount assembly and methods of forming and installing the winch mount assembly.

Some vehicles, such as trucks and sport utility vehicles, are equipped with a winch at the front of the vehicle. The winch may be used to pull objects or to assist a driver in getting the vehicle unstuck.

A winch may be attached to the front of the vehicle using a winch mount assembly. The winch mount assembly supports the winch and may improve the appearance of the vehicle by covering the winch that protrudes from the front of the vehicle.

Winch mount assemblies often include numerous components that are bolted together. This provides flexibility and tolerances to allow adjustment of the winch mount parts to accommodate the vehicle on which it is to be mounted. However, it may take an installer several hours to adjust and bolt all of the components together in order to mount the winch mount assembly to the vehicle. In addition, some drivers may consider the outer appearance of the vehicle to be undesirable if a large number of bolts is visible. Furthermore, the components may vibrate against each other if bolts loosen, which is undesirable.

### SUMMARY

Aspects of the disclosure include a winch mount assembly that is fully integrated together prior to installation. The winch mount assembly can thus be mounted to the vehicle in a short period of time because it is not necessary to assemble and adjust all of the components at each vehicle. The fully integrated winch mount assembly can simply be attached to the vehicle. The outer appearance of the winch mount assembly is also improved because the winch mount assembly can appear to be a single fabricated piece. The components also do not vibrate against each other because they are integrated together.

A vehicle winch mount assembly can include a main section; a driver side mount that is to be mounted to a vehicle and that is integrated with the main section; and a passenger side mount that is to be mounted to the vehicle and that is integrated with the main section. The method of forming the vehicle mount assembly can include integrating a driver side mount that is to be mounted to a vehicle with a main section; and integrating a passenger side mount that is to be mounted to a vehicle with the main section. The assembly can be installed on a vehicle by simply attaching the pre-integrated assembly to the frame of the vehicle.

### BRIEF DESCRIPTION OF THE DRAWINGS

Various exemplary aspects of the disclosure will be described with reference to the drawings, wherein:

FIG. 1 is a front top perspective view of a winch mount assembly;

FIG. 2 is an exploded front perspective view of a winch mount assembly;

FIG. 3 is front bottom perspective view of a winch mount assembly;

FIG. 4 is a back perspective view of a winch mount assembly; and

FIG. 5 is a back perspective view of a winch mount assembly.

### DETAILED DESCRIPTION OF THE EMBODIMENTS

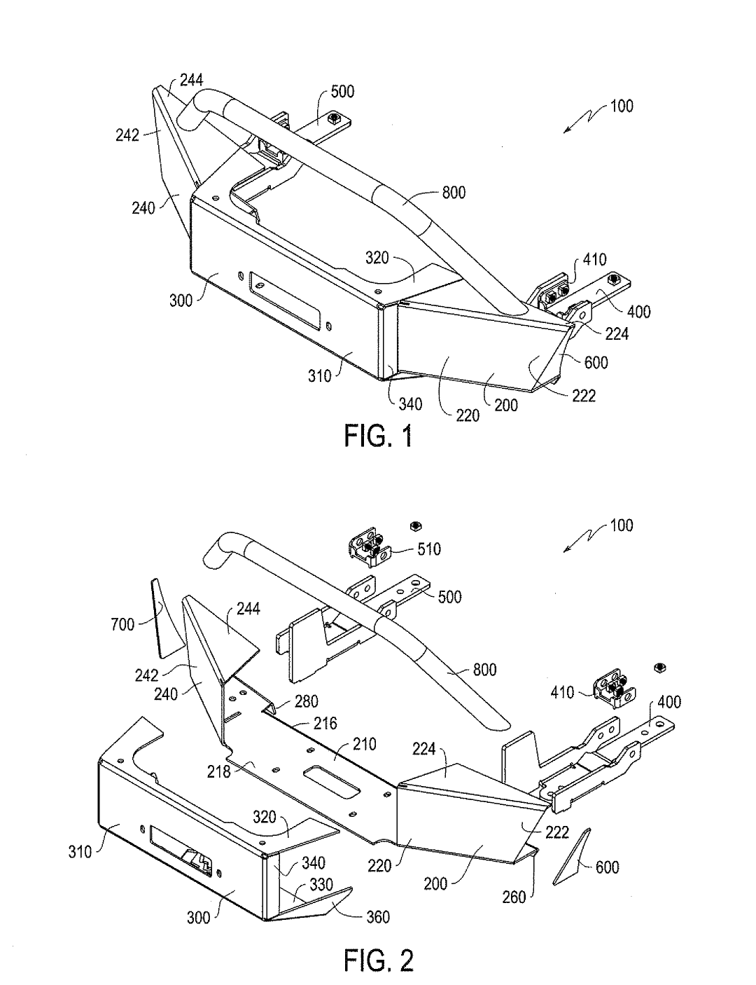

FIGS. 1-5 illustrate an exemplary winch mount assembly 100. The winch mount assembly 100 is designed to accommodate a winch (not shown). The winch mount assembly 100 includes a main section 200, a driver side mount 400, and a passenger side mount 500. The winch mount assembly 100 is configured to be attached to the frame of a vehicle (such as a truck or a sport utility vehicle) and is to accommodate the design of the vehicle (e.g., the frame and the bumper). The overall appearance of the winch mount assembly 100 may be customized . The winch mount assembly 100 is also configured to accommodate the desired winch or range of winches to be used with the vehicle. The entire winch mount assembly 100 can be of any length, and can, for example, extend the width of the entire front of the vehicle, the width of the front of the vehicle between the headlights, or a width that is slightly larger than the width of the winch. The winch mount assembly 100 may also be customized to include headlights, tow hooks or any grill/light guard design (for example, the tube 800), etc.

The main section 200 includes a mounting plate 210. The mounting plate 210 is preferably substantially horizontal in order to stably position the winch on a top surface, for example, at the center of the mounting plate 210.

The main section 200 preferably includes a driver side portion 220 and a passenger side portion 240 respectively on the driver and passenger sides. The driver side portion 220 preferably includes a front part 222 that extends upwardly from the front of the mounting plate 210, with the bottom of the front part 222 curving, angled or stepped to meet the mounting plate 210, and a top part 224 that extends rearward from the top of the front part 222, with the front of the top part 224 curving, angled or stepped to meet the front part 222. The passenger side portion 240 similarly preferably includes a front part 242 that extends upwardly from the front of the mounting plate 210, with the bottom of the front part 242 curving, angled or stepped to meet the mounting plate 210, and a top part 244 that extends rearward from the top of the front part 242, with the front of the top part 244 curving, angled or stepped to meet the front part 242. Driver and passenger side end caps (600, 700) may be provided on the side portions 220, 240. The driver side portion 220 and the passenger side portion 240 can cover the driver side mount 400 and the passenger side mount 500 to improve the appearance of the assembly.

Inside edges of the top parts 224, 244 may be parallel to each other, or may lean inward or outward. For example, the inside edges of the top parts 224, 244 illustrated by FIGS. 1 and 2 lean outward such that the distance between the top parts 224, 244 is greater at the back of the main section 200 than at the front.

The mounting plate 210 and the driver side portion 220/passenger side portion 240 can have any shape. For example, the top parts 224, 244, and the part of the mounting plate 210 opposite the top parts 224, 244, can have a square, rectangular, triangular, or any other suitable shape. For example, the top parts 224, 244, and the part of the mounting plate 210 opposite the top parts 224, 244, have a triangular shape as illustrated in FIG. 1. The top parts 224, 244 and the parts of the mounting plate 210 opposite the top parts 224, 244 can have different shapes.

The center of the mounting plate 210 between the driver side portion 220 and the passenger side portion 240 can also have any shape. For example, as illustrated in FIG. 2, the front of the mounting plate 210 between the side portions 220, 224 can have an extension 218, and the back of the mounting plate 210 between the side portions 220, 224 can have a cut-out 216. The extension 218 and the cut-out 216 can be used to accommodate the design of the vehicle and the winch, and can be used to improve to improve the appearance of the winch mount assembly 100.

The main section 200 may also include a driver side lip 260, a center lip 270 and/or a passenger side lip 280 at the back of the mounting plate 210. The center lip 270 is preferably at the cut-out 216 of the mounting plate 210, with the driver side lip 260 and the passenger side lip 280 on the respective sides of the cut-out 216. The lips 260, 270 and 280 preferably extend downwardly from the back of the mounting plate 210, with the tops of the lips 260, 270 and 280 curving, angled or stepped to meet the mounting plate 210.

Optional center section 300 may preferably be formed to correspond to and mate with the shape of the main section 200 when the center section 300 is rigidly attached to the main section 200 by welding or the like as discussed below. The center section 300 includes a front part 310 that is preferably substantially vertical. The center section 300 may include a top part 320 that extends rearward from the top of the front part 310, with the front of the top part 320 curving, angled or stepped to meet the front part 310, The center section 300 may include a driver side wall 340 and a passenger side wall 350 that extend rearward from the sides of the front part 310, preferably with a length that corresponds to the length of the extension 218 of the mounting plate 210. The fronts of the side walls 340, 350 are preferably curved, angled or stepped to meet the front part 310.

The center section 300 may also include a bottom part 330 that extends at a downward angle from the bottom of the front part 310, with the front of the bottom part 330 curving, angled or stepped to meet the front part 310. The center section 300 may also include a driver side outer part 360 and a passenger side outer part 370 that extend at an upward angle from the bottom part 330, with the bottom of the outer parts 360 and 370 curving, angled or stepped to meet the bottom part 330.

The driver side mount 400 and the passenger side mount 500 may be welded, bolted or otherwise attached to the vehicle, preferably such that the winch mount assembly 100 is rigidly attached to the vehicle, for example, to the vehicle frame, chassis or body. The driver side mount 400 and the passenger side mount 500 are also attached to the vehicle such that the winch mount assembly 100 is at an appropriate height and horizontally positioned. If for example, the driver side mount 400 and the passenger side mount 500 are to be bolted to the vehicle, nut tabs 410, 510 may be attached to the respective side mounts 400, 500 in order to stably attach the winch mount assembly 100 to the vehicle.

Appropriate materials from which the winch mount assembly 100 may be formed include metals that can be integrated by co-forming, welding or the like. The winch mount assembly 100 may also be formed from aluminum or thermoplastic, thermosetting or other moldable materials such as metals, plastics and fiber-based material such as fiberglass. The main section 200, the center section 300, the driver side mount 400, the passenger side mount 500, the driver side end cap 600 and the passenger side end cap 700 can be formed by any appropriate method individually or together, such as stamping a single sheet of material or attaching various sheets of metal, casting or injection molding. The winch mount assembly 100 can include the main section 200, the driver side mount 400 that is to be mounted to a vehicle and that is integrated with the main section 200; and the passenger side mount 500 that is to be mounted to the vehicle and that is integrated with the main section 200. The remaining components of the winch mount assembly 100 can optionally be integrated with the main section 200 or can be rigidly attached by bolts or the like.

The metal is preferably a heavy gauge sheet material (e.g., ¼ to ½, such as 5/16 to 7/16 or ⅜ inch thick metal) so that all of the components of the winch mount assembly 100 can be welded together and support the winch on the vehicle. Non-load-bearing components such as the center section 300 and/or end caps 600, 700 may be formed of lighter gauge metal or plastics. In other embodiments, the winch mount assembly 100 may be molded or cast. For example, injection molding may be particularly suitable for some thermoplastic materials, particularly high-density plastics. Casting may be appropriate for materials such as aluminum. Additional coating steps could be performed for coloring, corrosion resistance, non-slip properties and the like. For example, powder coating may be desirable for color matching with other vehicle components. Colored materials could also be used to form the winch mount assembly 100.

The term “integrated” means that two or more components are formed as a single piece of material by plastic deformation (e.g., stamping, bending), casting or molding (e.g., injection molding). For example, the main section 200 and the driver side mount 400 and/or passenger side mount 500 may be a single piece cast together. The term further includes two or more components permanently attached together by welding or the like as described above. The term “integrated” does not mean that the two or more components are temporarily attached together by bolts or the like such that the two or more components can be non-destructively separated by unscrewing the bolts.

There are various ways of assembling the main section 200, the center section 300, the driver side mount 400, the passenger side mount 500, the driver side end cap 600 and the passenger side end cap 700 such that the winch mount assembly 100 is rigidly integrated. The following is one example for assembling the various components by welding before the winch mount assembly 100 is mounted on the vehicle. The order in which the various components can be assembled can vary according to preference or according to the vehicle model in which the winch mount assembly 100 is mounted.

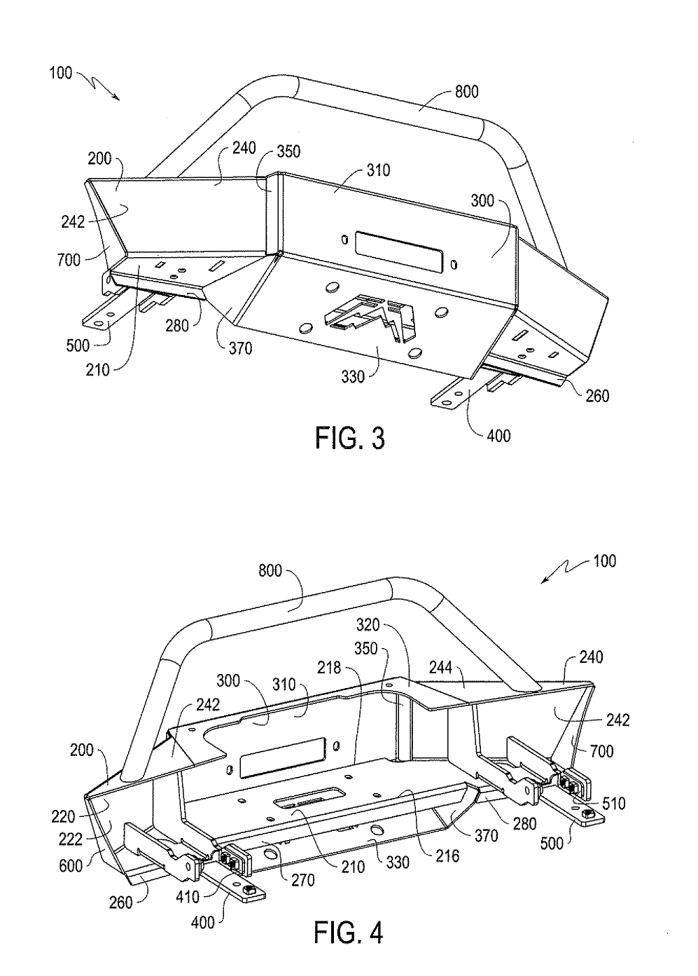

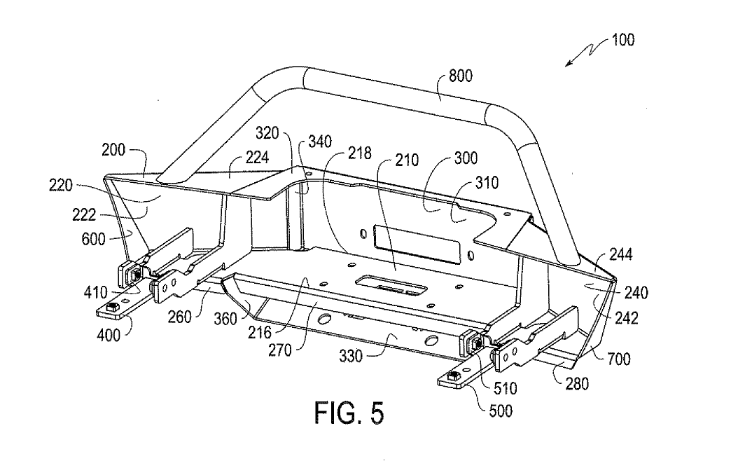

As illustrated in an exemplary manner by FIGS. 1-5, the center section 300 is placed in abutment with the main section 200. The top surface of the top part 320 of the center section 300 is at the same height as the top surfaces of the top parts 224, 244 of the side portions 220, 240 as illustrated by FIG. 1. The top parts 220, 240 and 320 can then be attached to each other by welding, for example. As illustrated in an exemplary manner by FIGS. 1 and 3, the backs of the side walls 340, 350 are placed against the front, inside edges of the front parts 222, 242. The side wall 340 and the front part 222 and the side wall 350 and the front part 242 can then be attached to each other by welding. In addition, as illustrated by FIGS. 4 and 5, the front of the mounting plate 210 is in abutment with the back of the front part 310 at the extension 218. The front of the mounting plate 210 and the back of the front part 310 can then be attached to each other by welding.

The tops of the outer parts 360, 370 are placed in abutment with the bottom surface of the mounting plate 210 as illustrated by FIG. 3, and can then be attached to the bottom surface 214 by welding. As illustrated by FIGS. 4 and 5, the top, back edges of the outer parts 360, 370 are placed in abutment with and aligned with the inside edges of the lips 260, 280, and can be attached by welding. In addition, the outside edges of the center lip 270 are placed in abutment with the outer parts 360, 370, and can be attached by welding. Furthermore, the outside edges of the cut-out 216 between the lips 260, 280 and the center lip 270 and the outer parts 360, 370 are placed in abutment, and can be attached by welding.

The side mounts 400, 500 are placed in abutment with the top surface of the mounting plate 210 as illustrated by FIGS. 4 and 5. The side mounts 400, 500 are positioned such that the winch mount assembly 100 can be centered on the front of the vehicle and so that the winch mount assembly 100 can be attached to the vehicle. The side mounts 400, 500 can then be attached to the mounting plate 210 by welding. The nut tab 410 may be placed in abutment with the top surface of the side mount 400 and the nut tab 510 may be placed in abutment with the top surface of the side mount 500 and attached by welding.

The side mounts 400, 500 are also placed in abutment with the back of the side portions 220, 240 as illustrated by FIGS. 4 and 5. The side mounts 400, 500 can then be attached to the side portions 220, 240 by welding.

The side mounts 400, 500 can be fixed to the mounting plate 210 and the side portion 220, 240 because the manufacturing tolerances for vehicles continue to improve. The design and position of the vehicle frame, chassis and bumper to which the winch mount assembly 100 is attached are consistent with the same vehicle model. It is thus possible to assemble a large number of winch mount assemblies in the absence of the vehicles on which they are to be mounted. It is not necessary to provide side mounts 400, 500 that can be flexibly moved for each vehicle, and then bolted to the mounting plate 210. The winch mount assembly 100 can thus be mounted to the vehicle in a shorter period of time because it is not necessary to adjust and bolt the side mounts 400, 500 to the mounting plate 210 for each vehicle.

The driver side end cap 600 is placed in abutment with the outside edges of the driver side portion 220 and the mounting plate 210 as illustrated by FIGS. 1 and 4, and can be attached by welding. The passenger side end cap 700 is placed in abutment with the outside edges of the driver side portion 240 and the mounting plate 210 as illustrated by FIGS. 3 and 5, and can be attached by welding. The driver side end cap 600 and the passenger side end cap 700 cover the side mounts 400, 500.

The winch mount assembly 100 can also be customized to include one accessory or a plurality of accessories, including, but not limited to, headlights, tow hooks or any grill/light guard design. For example, FIG. 1 illustrates a tube 800 that is placed in abutment on top of the top parts 224, 244, and attached by welding. The one accessory or plurality of accessories may be welded, bolted or otherwise attached to the winch mount assembly tube 800 such that the one accessory or plurality of accessories may be rigidly attached to the winch mount assembly 100.

Various advantages can be achieved with embodiments of the winch mount assembly 100 and methods of forming and installing the winch mount assembly 100. For example, the winch mount assembly 100 is fully integrated together. The winch mount assembly 100 can thus be mounted to the vehicle in a short period of time because it is not necessary to adjust and bolt together each winch mount assembly 100 for each vehicle. The outer appearance of the winch mount assembly 100 is also improved because the winch mount assembly 100 can appear to be a single fabricated piece. Furthermore, a winch can be pre-installed on the pre-integrated mount assembly 100 if desired, by bolting, welding or otherwise.

While specific exemplary embodiments have been described, it is evident that many alternatives, modifications, and variations will be apparent to those skilled in the art. Accordingly, exemplary embodiments as set forth herein are intended to be illustrative, not limiting, and changes may be made without departing from the spirit and scope of the disclosure.

What is claimed is:

1. A uninstalled vehicle winch mount assembly, comprising:
a main section configured to support a winch;
a driver side mount that is integrated with the main section and configured to be attached to a vehicle; and
a passenger side mount that is integrated with the main section and configured to be attached to the vehicle.

2. The vehicle winch mount assembly according to claim 1, further comprising:
an upwardly extending center section integrated with the main section.

3. The vehicle winch mount assembly according to claim 2, wherein the main section includes a mounting plate, a driver side portion at one end of the mounting plate, and a passenger side portion at another end of the mounting plate, and
the center section is integrated with the mounting plate, the driver side portion and the passenger side portion.

4. The vehicle winch mount assembly according to claim 2, wherein the center section is integrated with a front end and a rear end of the main section.

5. The vehicle winch mount assembly according to claim 1, wherein:
the main section includes a mounting plate, a driver side portion at one end of the mounting plate, and a passenger side portion at another end of the mounting plate,
the driver side mount is integrated with the mounting plate and to the driver side portion, and
the passenger side mount is integrated with the mounting plate and to the passenger side portion.

6. The vehicle winch mount assembly according to claim 1, further comprising:
a driver side end cap that is integrated with one end of the main section; and
a passenger side end cap that is integrated with another end of the main section.

7. The vehicle winch mount assembly according to claim 1, further comprising:
a tube having two ends that are integrated with the main section.

8. The vehicle winch mount assembly according to claim 1, further comprising:
a winch mounted on the main section.

9. The vehicle winch mount assembly according to claim 1, wherein the driver side mount and the passenger side mount are integrated with the main section by welding.

10. A method of forming an uninstalled vehicle winch mount assembly, comprising:
integrating a driver side mount that is configured to be mounted to a vehicle with a main section that is configured to support a winch; and
integrating a passenger side mount that is configured to be mounted to a vehicle with the main section.

11. The method according to claim 10, wherein the main section includes a mounting plate, a driver side portion at one end of the mounting plate, and a passenger side portion at another end of the mounting plate, further comprising:
integrating an upwardly extending center section with the mounting plate, the driver side portion and the passenger side portion.

12. The method according to claim 11, wherein the center section is integrated with a front end and a rear end of the main section.

13. The method according to claim 10, wherein the main section includes a mounting plate, a driver side portion at one end of the mounting plate, and a passenger side portion at another end of the mounting plate, further comprising:
integrating the driver side mount with the mounting plate and with the driver side portion, and
integrating the passenger side mount with the mounting plate and with the passenger side portion.

14. The method according to claim 10, further comprising:
integrating a driver side end cap with one end of the main section; and
integrating a passenger side end cap with another end of the main section.

15. The method according to claim 10, further comprising:
integrating two ends of a tube with the main section.

16. The method according to claim 10, wherein the driver side mount and the passenger side mount are integrated with the main section by welding.

17. A method of installing a vehicle winch mount assembly on a vehicle, comprising:
attaching a vehicle winch mount assembly of claim 1 to a frame of the vehicle by attaching the driver side mount and the passenger side mount to the frame of the vehicle.

18. The method according to claim 17, wherein the attaching is performed by bolting.

19. The method according to claim 17, wherein the attaching is performed by welding.

20. The method according to claim 17, further comprising:
attaching a winch to the vehicle winch mount assembly before attaching the vehicle winch mount assembly to the vehicle.
